(19) United States
(12) Patent Application Publication
(10) Pub. No.: US 2008/0100859 A1
(43) Pub. Date: May 1, 2008

(54) Image Forming Device

(75) Inventor: Takaaki SHIRAI, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 11/874,428

(22) Filed: Oct. 18, 2007

(30) Foreign Application Priority Data
Oct. 31, 2006 (JP) 2006-295963

(51) Int. Cl. G06F 3/12; G06F 15/00; H04N 1/32

(52) U.S. Cl. 358/1.13; 358/1.15; 358/1.16

(57) ABSTRACT

An image forming device includes a plurality of communication interfaces, a performing unit, and a restring unit. Each of the plurality of communication interfaces receives a command from an external device and has a type different from each other. The performing unit is capable of performing one of a plurality of functions in response to the command. The restricting unit restricts the performing unit to perform the function corresponding to the command, based on the type of the communication interface into which the command is inputted.

### CROSS REFERENCE TO RELATED APPLICATION

This application claims priority from Japanese Patent Application No. 2006-295963 filed Oct. 31, 2006. The entire content of each of these priority applications is incorporated herein by reference.

### TECHNICAL FIELD

The present invention relates to an image forming device, an image forming system, a computer-readable program, and a method of restricting a function provided in the image forming device.

### BACKGROUND

An image forming device which employs a plurality types of interfaces has been available. For example, Japanese Unexamined Patent Application Publication No. 2003-337663 discloses an image forming device which employs parallel, USB, and IEEE 1394 interfaces.

In recent years, an image forming device has been obtaining more and more functions; in addition to an image forming function, other new functions such as a facsimile function and a scanner function have been added to the image forming device. Such an image forming device capable of providing a plurality of functions is used in various ways.

### SUMMARY

It is an object of the present invention to provide a configuration capable of restricting each function as required on an interface basis.

In order to attain the above and other objects, the present invention provides an image forming device including a plurality of communication interfaces, a performing unit, and a restring unit. Each of the plurality of communication interfaces receives a command from an external device and has a type different from each other. The performing unit is capable of performing one of a plurality of functions in response to the command. The restricting unit restricts the performing unit to perform the function corresponding to the command, based on the type of the communication interface into which the command is inputted.

Another aspect of the present invention provides an image forming system including an image forming device, a performing unit, and a restricting unit. The image forming device includes a plurality of communication interfaces each configured to receive a command from an external device and having a type different from each other. The performing unit is capable of performing one of a plurality of functions in response to the command. The restricting unit restricts the performing unit to perform the function corresponding to the command, based on the type of the communication interface into which the command is inputted.

Another aspect of the present invention provides a storage medium storing a set of program instructions executable on an image forming device including a plurality of communication interfaces each configured to receive a command from an external device and having a type different from each other. The set of program instructions includes a performing unit and a restricting unit. The performing unit is capable of performing one of a plurality of functions in response to the command. The restricting unit restricts the performing unit to perform the function corresponding to the command, based on the type of the communication interface into which the command is inputted.

Another aspect of the present invention provides a method of restricting a function provided in an image forming device. The image forming device includes a plurality of communication interfaces and a performing unit. Each of the plurality of communication interfaces receives a command from an external device and has a type different from each other. The performing unit is capable of performing one of a plurality of functions in response to the command. The method includes a) determining whether or not to allow the performing unit to perform the function corresponding to the command, based on the type of the communication interface into which the command is inputted, and b) restricting the performing unit to perform the function corresponding to the command, based on the determination in a).

### BRIEF DESCRIPTION OF THE DRAWINGS

The particular features and advantages of the invention as well as other objects will become apparent from the following description taken in connection with the accompanying drawings, in which:

FIG. 1 is a perspective view schematically showing an image forming device according to a first embodiment;

FIG. 2 is a block diagram conceptually showing the electrical configuration of the image forming device shown in FIG. 1;

FIG. 3 illustrates a connection of the image forming device shown in FIG. 1 to external devices;

FIG. 4 is a table of corresponding information to be used for the image forming device according to the first embodiment;

FIG. 5 is a flowchart showing how a table is produced;

FIG. 6 is a flowchart showing how a function is performed;

FIG. 7 illustrates a connection of the image forming device according to a second embodiment;

FIG. 8 is a table of corresponding information to be used for the image forming device according to the second embodiment;

FIG. 9 illustrates a connection of the image forming device according to a third embodiment; and

FIG. 10 is a table of corresponding information to be used for the image forming device according to the third embodiment.

### DETAILED DESCRIPTION

The terms “upward”, “downward”, “upper”, “lower”, “above”, “below”, “beneath” and the like will be used throughout the description assuming that the image forming device is disposed in an orientation in which it is intended to be used.

### FIRST EMBODIMENT

Hereinafter, a first embodiment of the present invention will be described with reference to the accompanying drawings.

1. Overall Structure

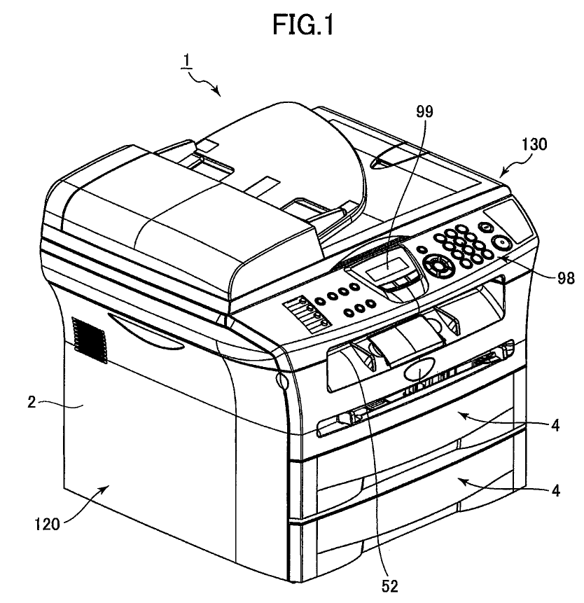

The image forming device according to this embodiment is a multi function printer 1 which serves as a printer, a scanner, a copier, and a facsimile machine. FIG. 1 is a perspective view schematically showing the multi function printer 1.

The multi function printer 1 includes a printer unit 120 and a scanner unit 130. The printer unit 120 is a color laser printer which forms an image. The printer unit 120, which is a tandem-type color laser printer, includes the following components in a main body case 2: a feeder unit 4 which feeds a sheet of paper as a recording medium; an image forming unit (not shown) which forms a given image on the fed sheet; and a discharge unit (not shown) which discharges the sheet therethrough, having the image thereon. The sheet which has been discharged through the discharge unit is discharged onto the discharge tray 52. The image forming unit is a known color printer system which performs exposure to light, transfer, fixing, and the like. The image forming unit allows selection between monochrome printing and color printing. The discharge unit includes discharge rollers; and a discharge path which guides the sheet having the image thereon formed by the image forming unit, to the discharge tray 52.

The scanner unit 130 is a flatbed-type scanner which scans an original document. The scanner unit 130 is provided above the printer unit 120, out of contact with each other. In a forward portion of the scanner unit 130, the following components are provided: a console unit 98 which allows a user to operate the multi function printer 1 therethrough; and a display unit 99 which displays the setting status of the multi function printer 1. As the scanner unit 130 scans an original document, the scanned data is printed by the printer unit 120 when the copier function is selected. Alternatively, the scanned data is faxed when the facsimile function is selected.

2. Electrical Configuration

Next, a description is given for the electrical configuration of the multi function printer 1.

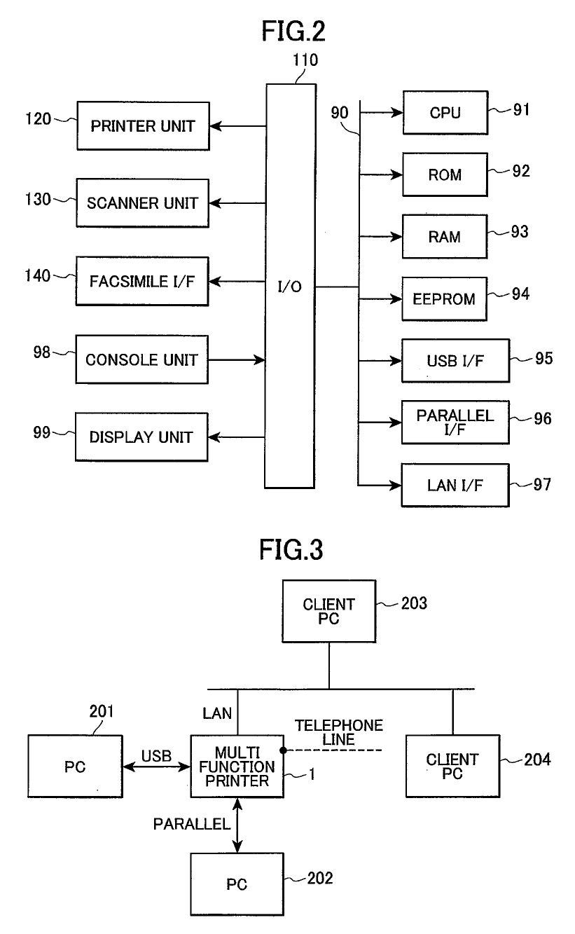

FIG. 2 is a block diagram conceptually showing the electrical configuration of the multi function printer 1. As shown in FIG. 2, the multi function printer 1 includes a CPU 91, a ROM 92, a RAM 93, an EEPROM 94 as a nonvolatile memory, a bus line 90, an input/output port 110 connected to the bus line 90 (referred to as an “I/O” in the figure). The multi function printer 1 further includes the console unit 98 having various kinds of buttons and a touch panel; and the display unit 99 having a liquid crystal display panel and an indicator.

The multi function printer 1 further includes plural types of communication interfaces for receiving various types of data including print data therethrough from an external device (referred to as an “I/F” in the figure). FIG. 2 shows an example in which the following interfaces are employed: a universal serial bus (USB) interface 95, a parallel interface 96, a LAN interface 97, and a facsimile interface 140.

The USB interface 95 is an interface which inputs/outputs information in accordance with the USB standard as a serial bus standard.

The parallel interface 96 is a communication interface capable of transferring plural pieces of bit information simultaneously.

The LAN interface 97 is an interface which inputs/outputs information to/from a local area network. For example, the LAN interface 97 is an interface which inputs/outputs information in accordance with an IEEE 802-x standard (IEEE 802.1, IEEE 802.2, IEEE 802.3, IEEE 802.4, IEEE 802.5 etc.).

The facsimile interface 140 serves a telephone line interface to transmit/receive a document by facsimile. The facsimile interface 140 includes an NCU connected to a telephone line for line control; a modem which modulates/demodulates image data for transmission as well as transmits/receives various kinds of transmission control procedure signals; a buffer which temporarily stores facsimile data including encoded image data to transmit to a destination facsimile machine, and receive therefrom. The NCU receives a ringing signal transmitted from a switchboard (not shown) provided externally to the multi function printer 1 via a telephone line (not shown). The NCU also receives the telephone number of a destination facsimile machine. The NCU transmits dial tone signals to the switchboard in response to the user's button operation on the console unit 98 for making a call. Furthermore, the NCU transmits/receives analog audio signals during the telephone call.

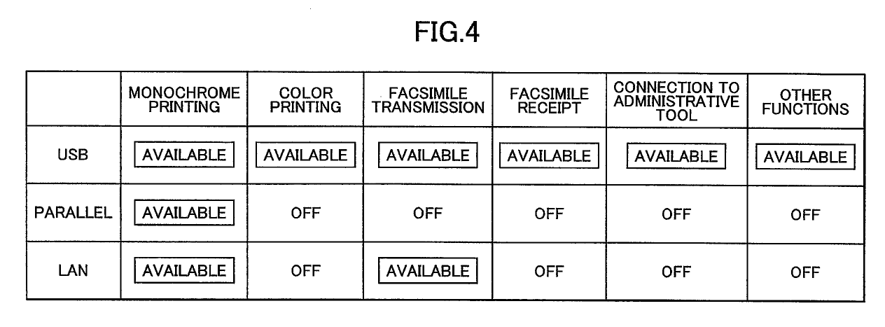

Via the various interfaces stated above, the CPU 91 produces a table shown in FIG. 4. After producing the table, determining of category, specifying of function, referring of the table, and determining of availability (to be described later) are performed based on the data entered from the external device.

The ROM 92 stores a program for controlling the multi function printer 1 as a whole. The CPU 91 controls the printer unit 120 and the scanner unit 130 of the multi function printer 1 based on the program.

3. Features

As has been described above, the multi function printer 1 according to this embodiment includes the communication interfaces 95, 96, 97 and 140 which allow a command to be entered from the external device. For example, the multi function printer 1 is connected to external devices (in this case, personal computers 201, 202, 203, and 204) in the manner shown in FIG. 3 so as to configure an image forming system to be employed in business service providers and the like. This configuration allows the multi function printer 1 to determine whether or not the function corresponding to a command among the functions provided in the multi function printer 1 can be performed, based on the type of the communication interface into which the command is inputted. Furthermore, based on the determination, the function corresponding to the command is controlled.

Referring to FIG. 4, the EEPROM 94 stores corresponding information for each communication interface type with availability on a function basis. As shown in FIG. 4, the corresponding information is made into the table which associates each interface-function with availability information as to whether or not the relevant function can be performed. For example, if the command enters into the USB interface 95, all the functions can be performed. If the command is inputted into the parallel interface 96, only the “monochrome printing function” can performed. If the command is inputted into the LAN interface, only the “monochrome printing function” and the “facsimile transmitting function” can be performed.

The CPU 91 determines, based on the type of the communication interface into which the command is inputted, and on the corresponding information stored in the EEPROM 94, whether or not the function corresponding to the command can be performed. Hereinafter, a description is given for the flow of a specific control.

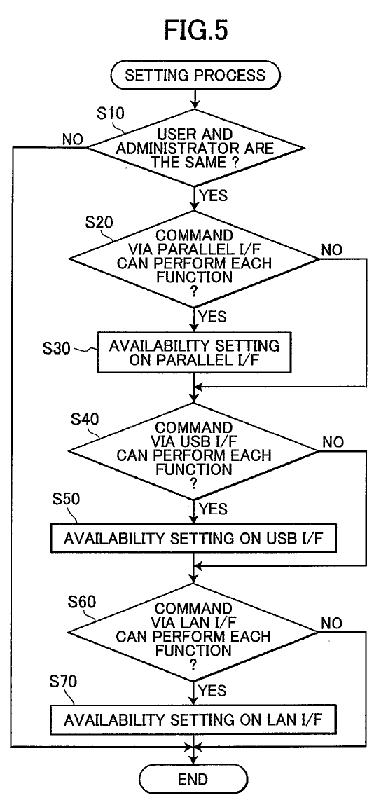

FIG. 5 is a flowchart for producing the table. The process is started in response to a predetermined operation through the console unit 98 (for example, in response to pushing of a switch (not shown) for starting a function restricting program in the setting menu). Firstly, the CPU 91 determines, based on the control program stored in the ROM 92, whether or not a user is an administrator (S10). For example, the display unit 99 asks the user to enter a password, and the CPU 91 determines whether or not the entered password is valid. If the password is valid, the process proceeds to S20. If the valid password has not been entered yet (for example, case in which an invalid password has been entered, or case in which no password has been entered over a predetermined period of time), the process is terminated.

Thus, in this embodiment, the CPU 91 determines whether or not the user who uses the multi function printer 1 through the console unit 98 in S10 is identical with the administrator. If the CPU 91 determines that the user is identical with the administrator, the EEPROM 94 can be updated as described later. If the CPU 91 determines that the user is not identical with the administrator, the EEPROM 94 can be not updated.

If Yes in S10, the CPU 91 determines whether or not to enable the multi function printer 1 to perform either of functions provided in the multi function printer 1 when the command is entered into the parallel interface 96, and determines the function to be available in response to the command inputted into the parallel interface 96 (S20). For example, the display unit 99 asks the user to enter whether or not to enable the multi function printer 1 to perform either of the functions, such as the “monochrome printing function”, the “color printing function”, and the “facsimile function”, when the command is inputted into the parallel interface 96. Further, the display unit 99 asks the user to enter which function he/she would like to make available in response to the command inputted into the parallel interface 96.

If Yes in S20, the CPU 91 produces a table based on the information entered through the console unit 98 (S30). For example, if the information indicating that the multi function printer 1 can perform only the “monochrome printing function” when the command is inputted into the parallel interface 96 is entered through the console unit 98, the table indicating that the parallel interface 96 accepts only the “monochrome printing function” is produced as shown in FIG. 4. The table is stored in the EEPROM 94, and then, the process proceeds to S40. If No in S20, the process also proceeds to S40.

Next, the CPU 91 determines whether or not to enable the multi function printer 1 to perform either of the functions provided in the multi function printer 1 when the command is entered into the USB interface 95, and determines the function to be available in response to the command inputted into the USB interface 95 (S40). For example, the display unit 99 asks the user to enter whether or not to enable the multi function printer 1 to perform either of the functions when the command is inputted into the parallel interface 96. Further, the display 99 asks the user to enter which function he/she would like to make available in response to the command inputted into the USB interface 95.

If Yes in S40, the CPU 91 produces a table based on the information entered through the console unit 98 (S50). For example, if the information indicating that the multi function printer 1 can perform all the provided functions when the command is inputted into the USB interface 95 is entered through the console unit 98, the table indicating that the USB interface 95 accepts all the functions is produced as shown in FIG. 4. The table is stored in the EEPROM 94, and then, the process proceeds to S60. If No in S40, the process also proceeds to S60.

Next, the CPU 91 determines whether or not to enable the multi function printer 1 to perform either of the functions provided in the multi function printer 1 when the command is inputted into the LAN interface 97, and determines the function to be available in response to the command inputted into the LAN interface 97 (S60). For example, the display unit 99 asks the user to enter whether or not to enable the multi function printer 1 to perform either of the functions when the command is inputted into the LAN interface 97. Further, the display 99 asks the user to enter which function he/she would like to make available in response to the command inputted into the LAN interface 97.

If Yes in S60, the CPU 91 produces a table based on the information entered through the console unit 98 (S70). For example, if the information indicating that the multi function printer 1 can perform only the “monochrome printing function” and the “FAX receiving function” when the command is inputted into the LAN interface 97 is entered through the console unit 98, the table indicating that the LAN interface 97 accepts only the “monochrome printing function” and the “FAX receiving function” is produced as shown in FIG. 4. The table is stored in the EEPROM 94, and then, the process is terminated. If No in S60, the process is also terminated.

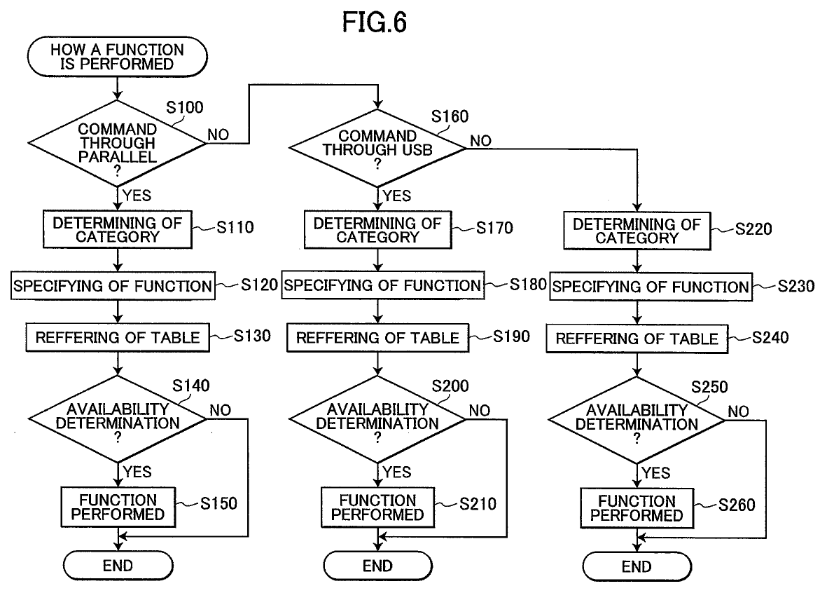

Next, a description is given as to how each function is performed when a command is inputted into each communication interface. FIG. 6 is a flowchart showing how a function is performed.

First, the CPU 91 determines whether or not the communication interface into which the command is inputted is the parallel interface 96 (S100).

If Yes in S100, the CPU 91 determines which category the function indicated by the command belongs to (S110). For example, based on head data of packets of the entered command, the CPU 91 determines which one of the following categories the function requested by the command belongs to: “printer function”, “facsimile function” and “other function”.

After that, the CPU 91 specifies the function requested by the command in detail based on the command (S120). For example, in the multi function printer 1 according to this embodiment, the category “printer function” includes the “monochrome printing function” and the “color printing function”. If the function requested by the entered command belongs to the category “printer function”, either of the “monochrome printing function” or the “color printing function” is specified.

Similarly, the category “facsimile function” includes the “facsimile transmitting function” and the “facsimile receiving function”. If the function requested by the entered command belongs to the category “facsimile functions”, either of the “facsimile transmitting function” or the “facsimile receiving function” is specified.

Similarly, if the function requested by the command belongs to the category “other function”, either of an “administrative-tool connecting function” or a “miscellaneous function” is specified.

Then, the CPU 91 fetches availability data corresponding to both the function specified in S120 and the communication interface into which the command is inputted, referring the table shown in FIG. 4 (S130). Let us take an example in which the function requested by the command is the “monochrome printing function”. In FIG. 4, the setting is such that the command inputted into the parallel interface 96 can perform the “monochrome printing function”. Therefore, the CPU 91 fetches the availability data indicating that the “monochrome printing function” is available. On the other hand, the setting is such that the “color printing function” cannot be performed. Therefore, the CPU 91 fetches the availability data indicating that the “color printing function” is unavailable.

Based on the availability data obtained in S130, the CPU 91 determines whether or not the function specified in S120 is available (S140). If the CPU 91 determines that the specified function is available, the process proceeds to Yes in S140 so as to perform the specified function (S150). On the other hand, the CPU 91 determines that the function is unavailable in S140, the process proceeds to No in S140, thereby completing the process.

Next, a description is given for the case in which the process proceeds to No in S100. If No in S100, the CPU 91 determines whether or not the communication interface into which the command is inputted is the USB interface 95 (S160). If Yes in S160, the CPU 91 determines which category the function indicated by the command belongs to (S170). For example, based on an end point of the command, the CPU 91 determines which one of the following categories the function requested by the command belongs to: “printer function”, “facsimile function” and “other function”.

After that, the CPU 91 specifies the function similarly to S120 (S180), and fetches the availability data similarly to S130 (S190). Furthermore, the CPU 91 determines whether or not the function specified in S180 is available similarly to S140 (S200), and then performs the specified function similarly to S150 (S210).

In this embodiment, the command inputted into predetermined communication interfaces (the USB interface 95 in FIG. 4) can perform the “color printing function”. On the other hand, the command inputted into the other communication interface apart from the predetermined communication interfaces cannot perform the “color printing function”. This is effective in reducing the running costs of the multi function printer 1.

In the multi function printer 1 according to this embodiment, the category “facsimile function” includes the “facsimile transmitting function” and the “facsimile receiving function”. In the example shown as FIG. 4, only the command inputted into the USB interface 95 can perform the “facsimile receiving function”. On the other hand, the command inputted into either one of the communication interfaces apart from the USB interface 95 cannot perform the “facsimile receiving function”. The “facsimile receiving function” allows the facsimile data which has been received by the multi function printer 1 via the telephone line, to be received by an external device such as a personal computer. The “facsimile receiving function” is performed in response to the request command received through the external device. In the example of FIG. 4, specifically, in order to transmit the facsimile data which has been received by the multi function printer 1 via the telephone line, to the external device, the data has to be inputted into the USB interface 95. The request command received via the external device may be issued in response to the access of the multi function printer 1 to the external device (predetermined communication), or may be issued voluntarily by the external device.

Furthermore, in the example shown as FIG. 4, only the command inputted into either the USB interface 95 or the LAN interface 97 can perform the “facsimile transmitting function”. On the other hand, the command inputted into the parallel interface 96 cannot perform the “facsimile transmitting function”. The “facsimile transmitting function” allows facsimile data to be transmitted via the telephone line and the facsimile interface 140, as long as image data and data to be transmitted (including a telephone number) has been transmitted from the external device such as a personal computer to the multi function printer 1. In the example of FIG. 4, the facsimile transmitting function can be performed only in the case where image data and data requested to be transmitted (including a telephone number) has been transmitted to the multi function printer 1 via the USB interface 95 or the LAN interface 97.

Next, a description is given for the case in which the process proceeds to No in S160. If No in S160, the CPU 91 determines which category the function indicated by the command belongs to (S220). For example, based on a port through which the command is inputted, the CPU 91 determines which one of the following categories the function requested by the command belongs to: “printer function”, “facsimile function” and “other function”.

After that, the CPU 91 specifies the function similarly to S120 (S230), and fetches the availability data similarly to S130 (S240). Furthermore, the CPU 91 determines whether or not the function specified in S230 is available similarly to S140 (S250), and then performs the specified function similarly to S150 (S260). In this case, since the command is inputted into the LAN interface 97, only the “monochrome printing function” or the “facsimile transmitting function” are available; the other functions cannot be performed.

As has been described above, in this embodiment, based on the type of the communication interface into which a command has been inputted, a determination is made whether or not the function corresponding to the command can be performed. Therefore, the function that can be performed is restricted according to types of interfaces.

In this embodiment, the multi function printer 1 includes the EEPROM 94 which stores the corresponding information associating each communication interfaces type with availability on a function basis. A determination is made whether or not the function corresponding to the inputted command can be performed, based on the type of the communication interface into which the command has been inputted. The determination is also based on the corresponding information stored in the EEPROM 94. This preferably allows a determination to be made, whether or each function is to be restricted, with a simple configuration, instead of a complicated configuration, in order to restrict each function according to types of interfaces.

In this embodiment, the multi function printer 1 includes the console unit 98 through which updating information is entered. The CPU 91 updates the contents stored in the EEPROM 94, based on the updating information entered through the console unit 98. This configuration allows the settings for restricting each function to be changed according to the environment where the multi function printer 1 is placed.

Also in this embodiment, a determination is made whether or not a user who has entered updating information is identical with an administrator. The CPU 91 updates the contents stored in the EEPROM 94 if a determination has been made that the user is identical with the administrator. On the other hand, if the user is not the administrator, the CPU 91 does not update the contents. This configuration allows only the administrator to update the stored contents, thereby effectively preventing any person other than the administrator from changing the setting of the multi function printer 1.

Also in this embodiment, the “monochrome printing function” and the “color printing function” are available in the multi function printer 1. The “color printing function” can be performed when the command is inputted into a specific type of communication interface. On the other hand, these functions cannot be performed when the command is inputted into any other communication interface than the specific type. This configuration prevents the “color printing function” from being performed through any other communication interface than the specific type. Color printing cannot be performed through the other interfaces without any restriction, thereby effectively minimizing the cost for printing.

Also in this embodiment, the “facsimile function” of making the setting and performing information-processing for transmitting/receiving a fax, are available in the multi function printer 1. The “facsimile function” includes the “facsimile transmitting function” and the “facsimile receiving function”. The “facsimile function” can be performed when the command is inputted into a specific type of communication interface. On the other hand, these functions cannot be performed when the command is inputted into any other communication interface than the specific type. Specifically, this configuration prevents the “facsimile function” from being performed through any other communication interface than the specific type, so as to effectively avoid the situation that the “facsimile function” for making the setting and performing information-processing for transmitting/receiving a fax are performed unnecessarily through any other communication interface than the specific type.

### SECOND EMBODIMENT

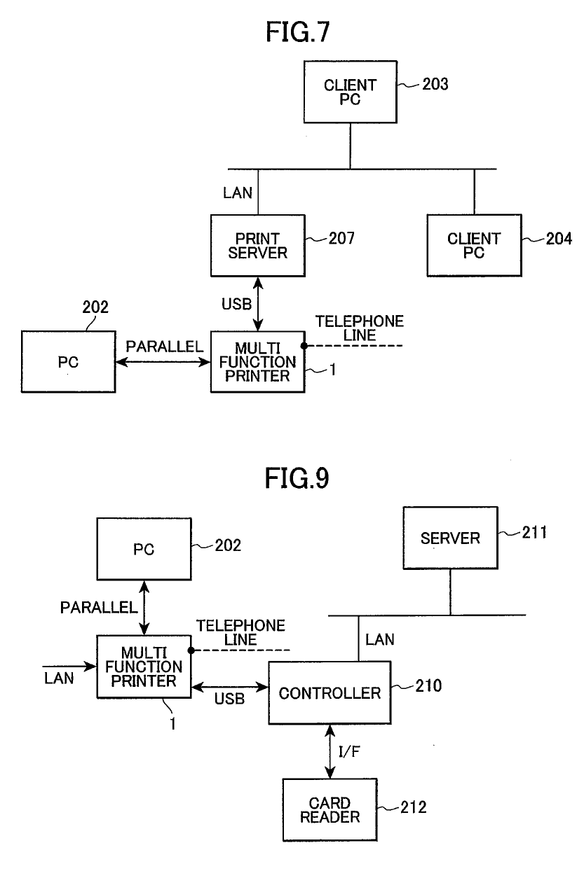

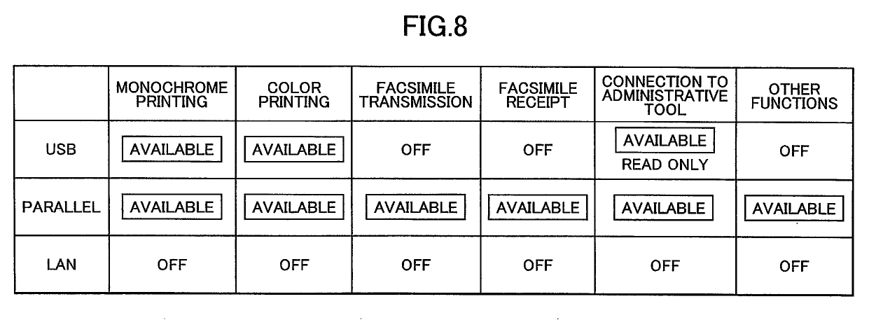

Next, a second embodiment of the present invention will be described with reference to FIG. 7 and FIG. 8.

The second embodiment is the same as the first embodiment except the corresponding information and the connection between the multi function printer 1, and except the external device. The components which serve similarly to the first embodiment have the same reference numbers, and their detailed description is omitted here. See FIG. 1 to FIG. 6 as required.

This embodiment relates to a case in which none of the provided functions is performed when the command is inputted into a predetermined communication interface. Specifically, referring to FIG. 7 and FIG. 8, the multi function printer 1 performs none of the functions if a command has been inputted into the LAN interface 97 (see FIG. 2). FIG. 7 shows an example in which the multi function printer 1 is not connected to a local area network. However, if an unauthorized external device should be connected to the LAN interface 97, this configuration prevents the command inputted into the LAN interface 97 from performing each function, thereby effectively stopping the multi function printer 1 from being abused in an unauthorized manner.

In this embodiment, a print server 207 is connected to the USB interface 95. Computers 203, 204, and the like are connected to the print server on the LAN. In this configuration, the command issued by each of the computers 203 and 204 is transmitted through the print server 207 and a USB cable; and entered into the USB interface 95 of the multi function printer 1.

The command issued by each of the computers 203 and 204, which means that the command is inputted into the USB interface 95, can perform only the “monochrome printing function”, the “color printing function”, and a “predetermined reading function” (see FIG. 8). In other words, only the “monochrome printing function”, the “color printing function”, and the “predetermined reading function” are made available by the command inputted from each of the computers 203 and 204. Examples of the “predetermined reading function” include a function of reading data from a predetermined administrative program which controls the multi function printer 1 so as to output the data at the external device. Specifically, provided that a billing program is prepared so as to charge a fee on a user basis, in accordance with use of the multi function printer 1, a function of reading billing information from the billing program corresponds to the predetermined reading function. The billing information is outputted to the external device. This configuration allows the multi function printer 1 to calculate a fee on a user basis, in accordance with use of the printer functions from each of the computers 203 and 204, with the billing program, so as to inform each of the computers 203 and 204 of the fee to be charged.

### THIRD EMBODIMENT

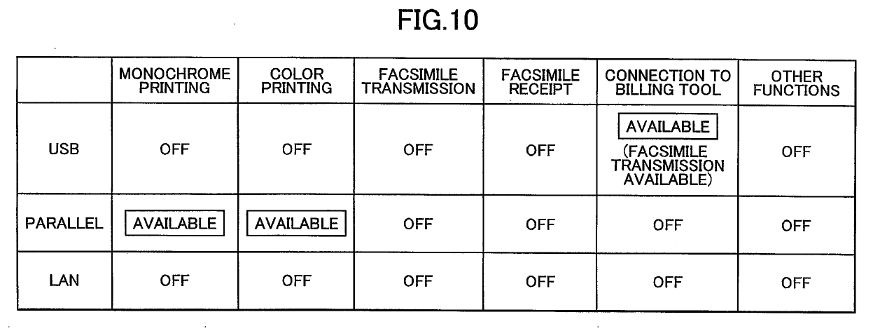

Next, a third embodiment of the present invention will be described with reference to FIG. 9 and FIG. 10.

The third embodiment is the same as the first embodiment except the corresponding information, and except the connection between the multi function printer 1 and the external device. The components which serve similarly to the first embodiment have the same reference numbers, and their detailed description is omitted here. See FIG. 1 to FIG. 6 as required.

Referring to FIG. 10, in this embodiment, only when the command is inputted into the parallel interface 96 (FIG. 2), the “printer function” (“color printing function” and “monochrome printing function”) can be performed.

Specifically, a controller 210, such as a personal computer, that can perform information processing is connected to the multi function printer 1. A card reader 212 is connected to the controller 210. An IC card or a magnetic card is read by the card reader 212 so as to identify the user to whom the card belongs. In order to execute printing by the multi function printer 1, the card has to be inserted into the card reader 212 while a print command is inputted from the computer 202. A billing program is prepared in the multi function printer 1 so as to generate fee data on a user basis, in accordance with the printed contents as printing has been executed.

The “billing control function” of making the setting or performing information-processing for billing is available in the multi function printer 1. The “billing control function” is performed by the billing program and the CPU 91. The “billing control function” is made available only by the command received via the USB interface 95. On the other hand, the “billing control function” is unavailable in response to the command received via any other communication interface than the USB interface 95. Examples of the setting for billing include how much a fee will be for each function. Examples of the information-processing for billing include billing information generation, and billing information reading (to read a fee on a user basis and to transmit the fee to the external device). In this embodiment, a server 211 is connected to the USB interface 95 through the controller 210 and a USB cable so that the server 211 can make the setting or perform information-processing for billing. On the other hand, neither the setting nor information-processing for billing can be specified through the parallel interface 96 or the LAN interface 97.

In this embodiment, the “billing control function” is performed through a predetermined type of communication interface. Specifically, this configuration prevents the “billing control function” from being performed through any other communication interface than the predetermined type, so as to effectively avoid the situation that the “billing control function” of making the setting or performing information-processing for billing is performed unnecessarily through any other communication interface than the predetermined type.

### OTHER EMBODIMENTS

The present invention is not limited to the above embodiments which have been described with reference to the accompanying drawings. For example, the following embodiments are included in the scope of the present invention.

The above embodiments relate to the case in which the category “facsimile function” gives information-processing for transmitting/receiving a fax as an example (specifically, facsimile transmitting function and facsimile receiving function). However, other functions may be included. The following are examples: a function of programming FAX and abbreviated numbers into the multi function printer 1; and a function of reading various kinds of data such as history of past transmission and receipt, and programmed telephone numbers.

Out of the functions covered by the above embodiments, a given function such as the scanner function may be unavailable.

The above embodiments relate to the case in which a command is entered through the USB interface, the parallel interface, and the LAN interface. However, other types of communication interfaces may also be employed. Examples of the available interface include a telephone line interface, connected to a telephone line, which inputs information via the telephone line. A USB host interface is also included, which inputs a command therethrough. The USB host interface, which is a USB (Universal Serial Bus)-compliant serial interface, serves as an information processor itself. For example, the USB host interface may be configured so as to perform communications in compliance with USB standards, and so as to process externally obtained information using the CPU.

In the image forming device having such a USB host interface, the present invention is applicable in the following situation: any one (for example, printer function) or all of the provided function is/are made unavailable by the command received through the USB host interface from the external device.

Further, the type of the interface may correspond a standard of a transmitting method.

What is claimed is:

1. An image forming device comprising:
a plurality of communication interfaces each configured to receive a command from an external device and having a type different from each other;
a performing unit capable of performing one of a plurality of functions in response to the command; and
a restricting unit configured to restrict the performing unit to perform the function corresponding to the command, based on the type of the communication interface into which the command is inputted.

2. The image forming device according to claim 1, wherein the type indicates a standard of a transmitting method.

3. The image forming device according to claim 1, wherein the plurality of communication interfaces includes at least two of a USB interface, a USB host interface, a parallel interface, a LAN interface, and a telephone line interface.

4. The image forming device according to claim 1, further comprising a storage unit configured to store corresponding information indicating a relationship between the type of the communication interface and the function restricted by the restricting unit when the command is inputted into the communication interface,
wherein the restricting unit restricts the performing unit to perform the function corresponding to the command, based on both the type of the communication interface into which the command has been inputted, and the corresponding information stored in the storage unit.

5. The image forming device according to claim 4, further comprising:
an input unit through which a user enters updating information; and
an updating unit configured to update the corresponding information stored in the storage unit based on the updating information.

6. The image forming device according to claim 5, further comprising a determining unit configured to determine whether or not the user who has entered the updating information is identical with an administrator,
wherein the updating unit updates the corresponding information stored in the storage unit only when the determining unit determines that the user who has entered the updating information is identical with the administer.

7. The image forming device according to claim 1, wherein the plurality of functions includes a monochrome printing function and a color printing function.

8. The image forming device according to claim 1, wherein the plurality of functions includes a charge setting function for setting a charge for using each of the plurality of functions based on the command.

9. The image forming device according to claim 1, wherein the plurality of functions includes a charge information generating function for generating charge information with respect to a user who has used at least one of the plurality of functions in response to the command.

10. The image forming device according to claim 9, wherein the plurality of functions includes an outputting function for outputting the charge information to the user.

11. The image forming device according to claim 1, wherein the plurality of functions includes a facsimile transmitting function, a facsimile receiving function, and a facsimile setting function for setting information with respect to the facsimile transmitting function and the facsimile receiving function.

12. An image forming system comprising:
an image forming device including a plurality of communication interfaces each configured to receive a command from an external device and having a type different from each other;
a performing unit capable of performing one of a plurality of functions in response to the command; and
a restricting unit configured to restrict the performing unit to perform the function corresponding to the command, based on the type of the communication interface into which the command is inputted.

13. A storage medium storing a set of program instructions executable on an image forming device including a plurality of communication interfaces each configured to receive a command from an external device and having a type different from each other, the set of program instructions comprising:
a performing unit capable of performing one of a plurality of functions in response to the command; and
a restricting unit configured to restrict the performing unit to perform the function corresponding to the command, based on the type of the communication interface into which the command is inputted.

14. A method of restricting a function provided in an image forming device, the image forming device including a plurality of communication interfaces and a performing unit, each of the plurality of communication interfaces configured to receive a command from an external device and having a type different from each other, the performing unit capable of performing one of a plurality of functions in response to the command, the method comprising:
a) determining whether or not to allow the performing unit to perform the function corresponding to the command, based on the type of the communication interface into which the command is inputted; and
b) restricting the performing unit to perform the function corresponding to the command, based on the determination in a).
